(19) United States
(12) Patent Application Publication
(10) Pub. No.: US 2005/0009684 A1
(43) Pub. Date: Jan. 13, 2005

(54) Alkali-resistant ceramic packing and its manufacturing process

(76) Inventors: Shengming Lin, Ningde City (CN); Jianshu Lee, Ningde City (CN)

Correspondence Address: CHARLES E. BAXLEY, ESQ., 90 JOHN STREET, THIRD FLOOR, NEW YORK, NY, 10038, US

(21) Appl. No.: 10/616,740

(22) Filed: Jul. 9, 2003

(51) Int. Cl. C04B 35/20

(52) U.S. Cl. 501/122; 501/128

(57) ABSTRACT

The present invention relates to a chemical industry, and more especially to a ceramic packing made of wollastonite, diopside, black tale and magnesite as main composition materials and employing clay as binder with high alkali-resistant and its manufacturing process. It can be used to produce variety size of rasching ring, saddle, super saddle, cross-partition ring and ceramic ball and so on advanced alkali-resistant ceramic packing. The main performance specification: water-absorption: <0.5%; bulk density: 2.35˜2.80 g/cm³; alkali-resistant: >99.5%; Mohs hardness: ≧6.6; the present invention has following feathers: the raw material is coming from wide source, the manufacturing process is simple, the production cost is lower and so on, and the goods are chiefly used in inside of the alkaline medium reaction tower in chemical industry.

### BACKGROUND OF THE INVENTION

1. Field of the Invention

The present invention relates to a chemical industry, and more especially to an alkali-resistant ceramic packing made of wollastonite, diopside, black tale and magnesite as main composition materials and employing clay as binder with high alkali-resistant property and its manufacturing process.

2. Description of Prior Art

In accordance with the conventional ceramic packing in the chemical industry so far, it typically employs kaolinite, feldspar and clay as main composition materials for manufacturing, so the common ceramic manufactured by above is generally called acid- resistant ceramic, with poor alkali-resistant property, so that it is easy to be bitten, loosen and soften, further to be failure as working in alkaline agent, therefore it can not be utilized in caustic soda, or soda, liquid ammonia and so on other alkaline agents for a long term. According to chemical-resisting test standard JC/T457-92 (1996), said common ceramic's alkali-resistant is about to get 86%, until so far in the state wide there is not any alkali- resistant ceramic packing, which employs common wide sources and is produced with simple manufacturing process, developed to get above 99.5% Alkali-resistant.

### OBJECTS AND SUMMARY OF THE INVENTION

It is therefore a main object of the present invention to provide an alkali-resistant ceramic packing employing wollastonite, diopside, black tale and magnesite as main composition materials and clay as binder to be manufactured and its manufacturing process. It is a ceramic composed of 2MgO.SiO₂, MgO.SiO₂, CaO.SiO₂ as main crystal phase, and its main chemical composition includes: SiO₂: 45.0-55.0%; MgO: 10.0-40.0%; CaO: 0-15%; Al₂O₃: 3.0-8.0%; thereby it can be made into different shapes of alkali-resistant ceramic packing such like rasching ring, saddle, super saddle, cross-partition ring and ceramic ball and so on in different size.

The manufacturing process of said alkali-resistant ceramic packing is divided into three parts such as the plastic clay preparing process, the semi-finished model manufacturing process and the alkali-resistant ceramic packing firing process, coordinating to the attached tables, the detail of manufacturing process of the present invention will be described in follows.

The plastic clay preparing process: in the present invention wollastonite, diopside, black tale and magnesite are used as main raw materials, as shown in table 1, the mixture ratio of every raw material is based on mass, and the ranges of the mixture ratio of the raw materials are shown in table 2.

TABLE 1
the chemical composition of the raw materials

| | SiO₂ | Al₂O₃ | Fe₂O₃ | TiO₂ | CaO | MgO | K₂O | Na₂O | Ignition loss |
|---|---|---|---|---|---|---|---|---|---|
| Wollastonite | 52.2 | — | 0.3 | — | 41.3 | 1.2 | — | — | 4.5 |
| Diopside | 53.7 | 2.7 | 0.7 | — | 20.5 | 19.5 | — | — | 2.5 |
| Black tale | 61.80 | 0.19 | 0.14 | 0.10 | 1.5 | 28.2 | — | — | 7.8 |
| Magnesite | 0.64 | 0.10 | 0.40 | — | 0.72 | 46.88 | — | — | 51.26 |
| Clay | 56.72 | 27.1 | 1.60 | 0.85 | 0.20 | 0.15 | 2.00 | 0.10 | 11.2 |

TABLE 2
the range of mixture ratio of every raw material

| | Raw material | | | | |
|---|---|---|---|---|---|
| | Wollastonite | Diopside | Magnesite | Black tale | Clay |
| Mixture ratio | 0˜30% | 0˜30% | 0˜30% | 0˜35% | 10˜25% |

In accordance with the requirement of the formulation, the raw materials are respectively treated in precomminution process firstly, then weighed following said mixture ratio, and put into the ball mill to process more than 20 hours, the proportion of the material, ball and water is 1:1.5:0.9, and the fineness of the discharge is limited in less 0.5% with 250 mesh, next put the slurry into the inside of the slush-pit, then sequentially process in sieving, deferrization, press-filtering, aging and de-airing pugging, and so on, so that plastic bonding clay is prepared for molding model. The main machines used in this process include ball mill, dual pump, press filter, wet deferrization device and de-airing pug mill.

Semi-finished model manufacturing process: in the present invention the extrusion forming is used in manufacturing different size alkali-resistant ceramic packing with different mold, within the water ratio of clay should be limited in the range of 20˜24%. Using the de-airing extrusion press ejects the prepared plastic clay into different size semi-finished goods. The key machine of the process is vacuum extrusion press, for meeting the requirement of molding model, the vacuum degree is controlled above −0.08MP as molding.

The alkali-resistant ceramic packing firing process: in the present invention the shuttle kiln or the tunnel kiln or advanced kilns is selected to be the firing equipment, meanwhile the moister content of pre-kiln semi-finished goods and kilned goods is seriously controlled. The firing temperature should be in 1200˜1300° C. Because the firing temperature range is so narrow that the firing temperature should be controlled in the lower limit, by properly reducing the firing temperature and delaying holding time, it can prevent the goods from over-firing and distortion. During this process full oxidizing is kept. The temperature of outputting goods should be lower than 200° C.

The key technological parameters of the present invention:
Fineness of pre-milling raw material: <10 mm.
Fineness of milled raw material: the sieved rest <0.5% with 250 mesh.
Model moister content: 20.0˜24.0%.
Vacuum degree of pug mill: −0.08˜0.10 Mpa.
Pre-kiln moister content: <5%.
firing temperature : 1200˜1300° C.

The main feathers of goods:
Water-absorption: <0.5%;
Alkali-resistant: >99.5%;
Bulk density: 2.35˜2.80g/cm³
Mohs hardness: ≧6.6;

The appreciable feathers of the present invention are to firstly employ wollastonite, diopside, black tale and magnesite as main composition materials to utilize manufacturing alkali-resistant ceramic packing following said manufacturing processes to produce variety size of rasching ring, saddle, super saddle, cross-partition ring and ceramic ball and so on advanced alkali-resistant ceramic packing, the raw material is coming from wide source, the manufacturing process is simple, the production cost is lower and so on, and the goods are chiefly used in inside of the alkaline medium reaction tower in chemical industry.

### BRIEF DESCRIPTION OF THE DRAWINGS

FIG. 1 is the manufacturing process flowchart of alkali-resistant ceramic packing.

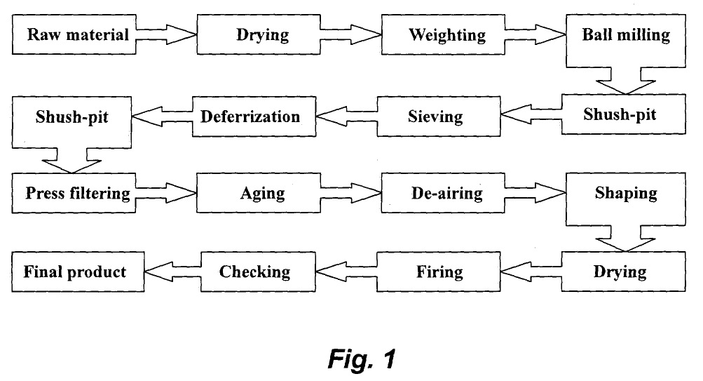

### DETAILED DESCRIPTION OF PREFERRED EMBODIMENTS

The first embodiment: according to above-mentioned manufacturing process, wollastonite, diopside, black tale and magnesite are employed as main composition materials, following wollastonite 20%, diopside 10%, black tale 26%, magnesite 26%, clay 18% weight 2000 kg, then following the technological process parameters, sequentially process in ball milling, sieving, deferrization treating, press filtering, aging and de-airing pugging for preparing plastic bonded clay for shaping, next take (φ25 saddle ring mold, and cooperate to a proper vacuum extrusion press to manufacture (φ25 make-up saddle rings, when said make-up saddle rings are dried, put them into a 5 m³ liquefied petroleum gas shuttle kiln, fire for 10 hours with temperature 1230° C., then naturally cool down to lower than 200° C. and take out from the kiln.

The second embodiment: the difference from said first embodiment is in increasing the scales of wollastonite, diopside and clay, and relatively reducing the scales of black tale and magnesite, and the firing temperature is controlled under 1210° C., other technological parameters and operation are as same as the first embodiment.

The third embodiment: the difference from said first embodiment is in increasing the scales of wollastonite, black tale, and reducing the scales of diopside, magnesite and clay, the firing temperature is controlled under 1250° C., the other conditions are not changed.

The fourth embodiment: the difference from the first embodiment is in increasing the scales of diopside, magnesite and clay, and reducing the scales of wollastonite, black tale, the firing temperature is controlled under 1240° C., the other conditions are not changed.

The embodiments from first to fourth apply mixture ratio of raw materials following table 3, depending on JC/T457-92(1996) and HG/T3210-(1986) regulations, check the quality of φ25 saddle rings, and the coordinated performance of goods is shown in table 4; as the result of checking, the performance of the goods can get to the technology requirement of ceramic tower packing in chemical industry.

TABLE 3
the mixture ratio of raw materials in every embodiment

| | The mixture ratio of raw materials (%) | | | | |
|---|---|---|---|---|---|
| embodiment | wollastonite | diopside | Black tale | magnesite | clay |
| 1^{st} | 20 | 10 | 26 | 26 | 18 |
| 2^{nd} | 30 | 15 | 20 | 15 | 20 |
| 3^{rd} | 25 | 5 | 35 | 23 | 12 |
| 4^{th} | 15 | 20 | 10 | 30 | 25 |

TABLE 4
the production quality of different goods in different
embodiment

| | Production quality | | | |
|---|---|---|---|---|
| | Water | Alkali - | Bulk density | Mohs |
| embodiment | absorption (%) | resistant (%) | (g/cm³) | hardness |
| 1^{st} | 0.14 | 99.85 | 2.68 | 7.0 |
| 2^{nd} | 0.38 | 99.62 | 2.52 | 6.7 |
| 3^{rd} | 0.35 | 99.51 | 2.48 | 6.6 |
| 4^{th} | 0.40 | 99.56 | 2.60 | 6.8 |

1. A ceramic with advanced alkali-resistant feather applied in chemical industry, wherein wollastonite, diopside, black tale and magnesite are employed as main raw composition material, clay as bonder for manufacturing.

2. An alkali-resistant ceramic as claimed in claim 1, wherein the range of mixture ratio of every raw material is wollastonite: 0˜30%, black tale: 0˜30%, clay: 10˜25%, diopside: 0˜30%, magnesite: 0˜30%.

3. An alkali-resistant ceramic as claimed in claim 1, wherein it is a ceramic composed of 2MgO.SiO₂, MgO.SiO₂, CaO.SiO₂ as main crystal phase, and its main chemical composition includes: SiO₂: 45.0-55.0%; MgO: 10.0-40.0%; CaO: 0-15%; Al₂O₃: 3.0-8.0%.

4. An alkali-resistant ceramic's manufacturing process as claimed in claim 1, wherein the preferred technological parameters are follows:
fineness of pre-milling raw material: <10 mm
fineness of milled raw material: the sieved rest <0.5% with 250 mesh
model moister content: 20.0˜24.0%
vacuum degree of pug mill: −0.08˜0.10 Mpa
pre-kiln moister content: <5%
firing temperature range: 1200˜1300° C.

5. An alkali-resistant ceramic as claimed in claim 1, wherein the main machines used in manufacturing include ball mill, dual pump, press filter, wet deferrization device and de-airing pug mill, vacuum extrusion press, shuttle kiln or tunnel kiln.
